(19) United States
(12) Patent Application Publication
(10) Pub. No.: US 2025/0090393 A1
(43) Pub. Date: Mar. 20, 2025

(54) Electric Motor Medical Chair

(71) Applicant: Reginald Keith Sapp, Clinton, MD (US)

(72) Inventor: Reginald Keith Sapp, Clinton, MD (US)

(21) Appl. No.: 18/750,823

(22) Filed: Jun. 21, 2024

(51) Int. Cl. A61G 5/04; A61G 5/10

(52) U.S. Cl. CPC A61G 5/046; A61G 5/1051

(57) ABSTRACT

The Electric Motor Medical Chair with Hand Brake is propelled by FIG. 4 L & R electric motors configuration.

It is designed to be control and stop by FIG. 2 L & R which will turn left, right, back, and forward. The feet can rest in FIG. 6. The front wheel as in FIG. 5 gives it better control.

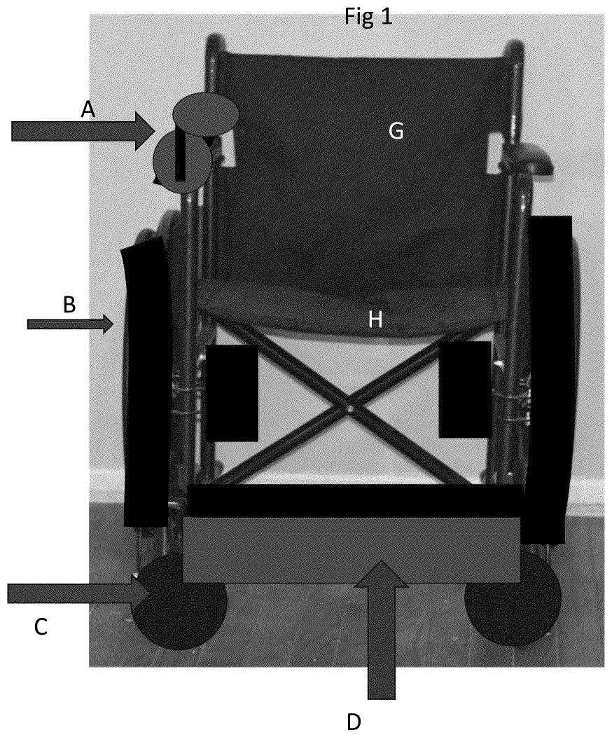

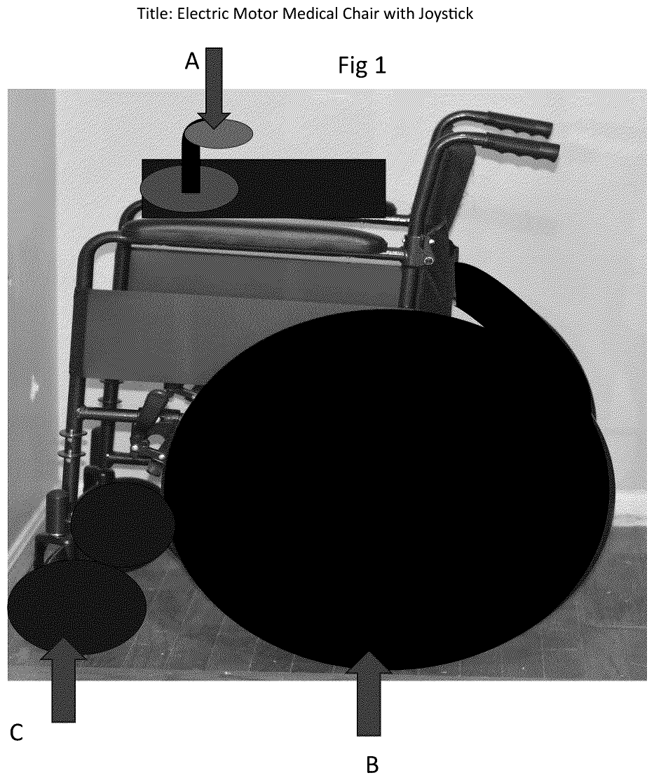

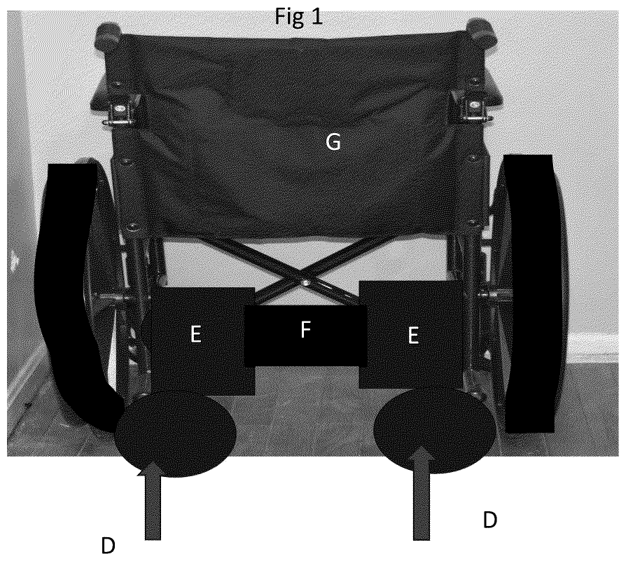

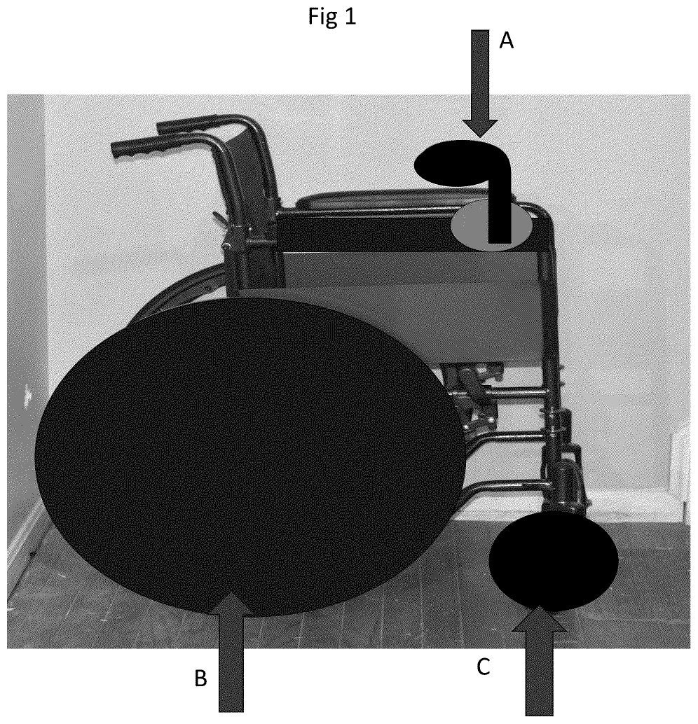

The chair in FIG. 3 is equipped to turn out for mounting and will adjust for comfort. It's Powered by FIG. 1 Lithium battery.

The Electric Motor Medical Chair with Joystick is propelled by FIG. 3 L & R electric motors. The footrest in FIG. 5 for comfort while traveling and the Joystick in FIG. 1 will turn left, right, back and forward. The wheelie bar as in FIG. 6 is for slops and balance while inclined.

This is a motorized medical chair for anyone who is unable to walk and required to travel with needed help. This is an electric motor chair that's has the compacity to move 2000 lbs+ by electric motors from Passenger Cars, Simi Trucks, Tractor Trailer Trucks or New electric motor build configuration.

The first test was with a 1979 Celica Toyota manual transmission shift starter motor. The second test was with a 1980,1981 Nissan 280ZX manual transmission shift starter motor.

The size of the motor is standard to all vehicle with piston engines, crankshafts with/without a Camshafts.

The motor is place at the base of the wheels on the chair. It can be single or duel motor due to the Force, and Drag formula. It has to have a JOY stick for turning and Navigation.

1. It was found that a car or a truck starter will compel a heavy object forward. The car weight between 5 lb to 2000 lb+. The test was done with a car starter. It was research that duel headers, and duel exhaust was the norm with cars.

2. It could not be balance with motor on one side due to car differential that spends both wheels. We concluded that duel motors was needed to balance the motion and weight forward. This is know as 4×4 All Wheel Drive.

3. The motor is a high amp motor which handle the stress of weight without burnout. It was needed a method to control the current to motion like a gas peddle. We examine F14 fighter Jet with a joy stick. This was our best option for controls.
